(19) United States
(12) Patent Application Publication
(10) Pub. No.: US 2008/0238693 A1
(43) Pub. Date: Oct. 2, 2008

(54) Individual Monitoring System

(76) Inventor: Frances F. Rebello, Chico, CA (US)

Correspondence Address: NEUSTEL LAW OFFICES, LTD., 2534 SOUTH UNIVERSITY DRIVE, SUITE 4, FARGO, ND, 58103, US

(21) Appl. No.: 11/693,559

(22) Filed: Mar. 29, 2007

(51) Int. Cl. G08B 23/00

(52) U.S. Cl. 340/573.4

(57) ABSTRACT

An individual monitoring system for efficiently monitoring when individuals stray from a designated area. The individual monitoring system generally includes a base unit and at least one sub unit to communicate with the base unit. The base unit transmits a first signal a predetermined distance, wherein the first signal does not transmit beyond the predetermined distance. The sub unit receives the first signal when the sub unit is within the predetermined distance of the base unit. The sub unit subsequently transmits a second signal to the base unit when the sub unit receives the first signal and the base unit receives the second signal transmitted by the sub unit. The sub unit transmits a third signal to the base unit when the sub unit does not receive the first signal before expiration of a timer. The base unit also includes at least one first alarming device, wherein the first alarming device is activated upon the base unit when the base unit receives the third signal thus alerting the base unit that at least one sub unit is beyond the predetermined distance.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to monitoring systems and more specifically it relates to an individual monitoring system for efficiently monitoring when individuals stray from a designated area.

2. Description of the Related Art

Any discussion of the prior art throughout the specification should in no way be considered as an admission that such prior art is widely known or forms part of common general knowledge in the field.

Monitoring systems have been in use for years and are utilized in a variety of industries and services. One area in which monitoring systems are utilized is to watch over young children/animals to ensure they don't stray from a designated area. Another area that may also utilize monitoring systems is in the area of patient care units.

Monitoring systems may serve several purposes. The monitoring systems may allow a leader or primary care giver to efficiently keep track of a large group of individuals. The monitoring systems also may install a sense of safety within the individual being monitored, wherein the individual feels safe that they are in the designated area.

Many commonly utilized monitoring systems do not incorporate features that allow the monitoring system to be easily managed to incorporate various changing entities, such as the number of people monitored, various distances utilized for boundary areas and various alarm devices. Because of the general lack of efficiency and practicality in the prior art there is the need for a new and improved individual monitoring system for efficiently monitoring when individuals stray from a designated area.

### BRIEF SUMMARY OF THE INVENTION

The general purpose of the present invention is to provide an individual monitoring system that has many of the advantages of the monitoring systems mentioned heretofore. The invention generally relates to a monitoring system which includes a base unit and at least one sub unit to communicate with the base unit. The base unit transmits a first signal a predetermined distance, wherein the first signal does not transmit beyond the predetermined distance. The sub unit receives the first signal when the sub unit is within the predetermined distance of the base unit. The sub unit subsequently transmits a second signal to the base unit when the sub unit receives the first signal and the base unit receives the second signal transmitted by the sub unit. The sub unit transmits a third signal to the base unit when the sub unit does not receive the first signal before expiration of a timer. The base unit also includes at least one first alarming device, wherein the first alarming device is activated upon the base unit when the base unit receives the third signal thus alerting the base unit that at least one sub unit is beyond the predetermined distance.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide an individual monitoring system for efficiently monitoring when individuals stray from a designated area.

Another object is to provide an individual monitoring system that may be managed utilizing a personal computer program (i.e. Microsoft Windows application, etc.).

An additional object is to provide an individual monitoring system that allows the leader to vary the number of activated sub units.

A further object is to provide an individual monitoring system that allows for the varying of the size of the area monitored.

Another object is to provide an individual monitoring system that is easy to use.

Another object is to provide an individual monitoring system that is portable.

Another object is to provide an individual monitoring system that allows for the use of various alerting devices.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention illustrating the main unit communicating with the sub units.

FIG. 2 is a flow chart of the present invention illustrating the use of the present invention.

FIG. 3 is a flow chart of the present invention illustrating the process of the internal circuitry of the present invention.

FIG. 4 is an upper perspective view of the base unit.

FIG. 5 is an upper perspective view of the base unit opened and revealing the internal components.

FIG. 6 is an upper perspective view of the sub unit.

FIG. 7 is an upper perspective view of the base unit connected to a personal computer.

FIG. 8 is a block diagram illustrating the connection between the base unit and the personal computer.

FIG. 9 is a front view of the pouch.

FIG. 10 is a rear view of the pouch.

### DETAILED DESCRIPTION OF THE INVENTION

### A. Overview

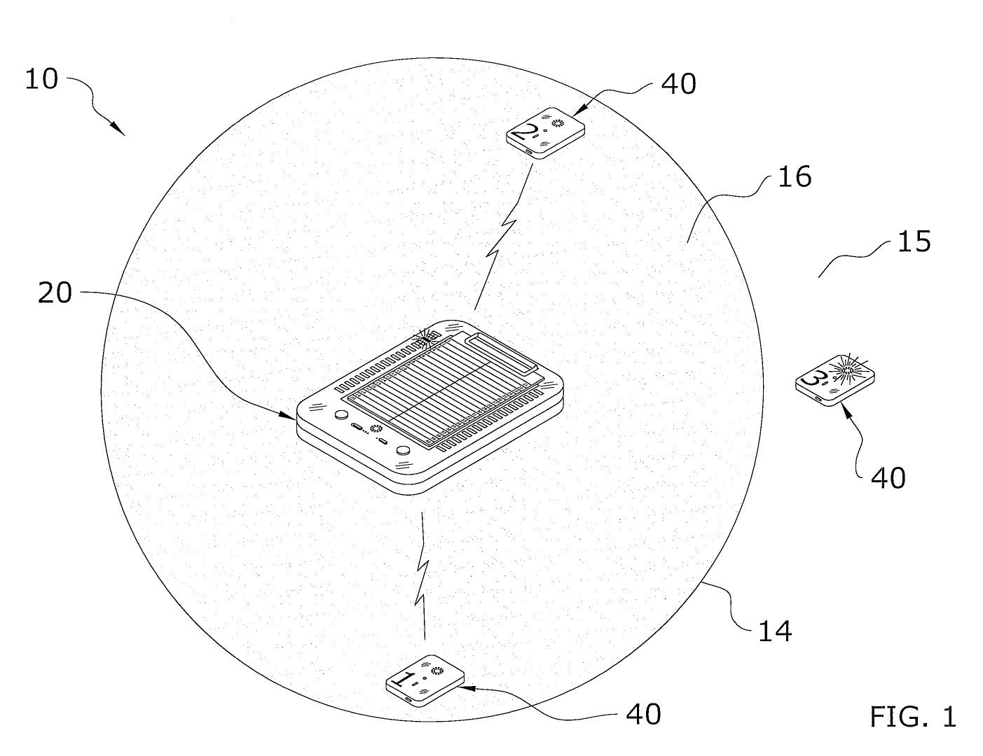

Turning now descriptively to the drawings, in which similar reference characters denote similar elements throughout the several views, FIGS. 1 through 10 illustrate an individual monitoring system 10, which comprises a base unit 20 and at least one sub unit 40 to communicate with the base unit 20. The base unit 20 transmits a first signal a predetermined distance, wherein the first signal does not transmit beyond the predetermined distance.

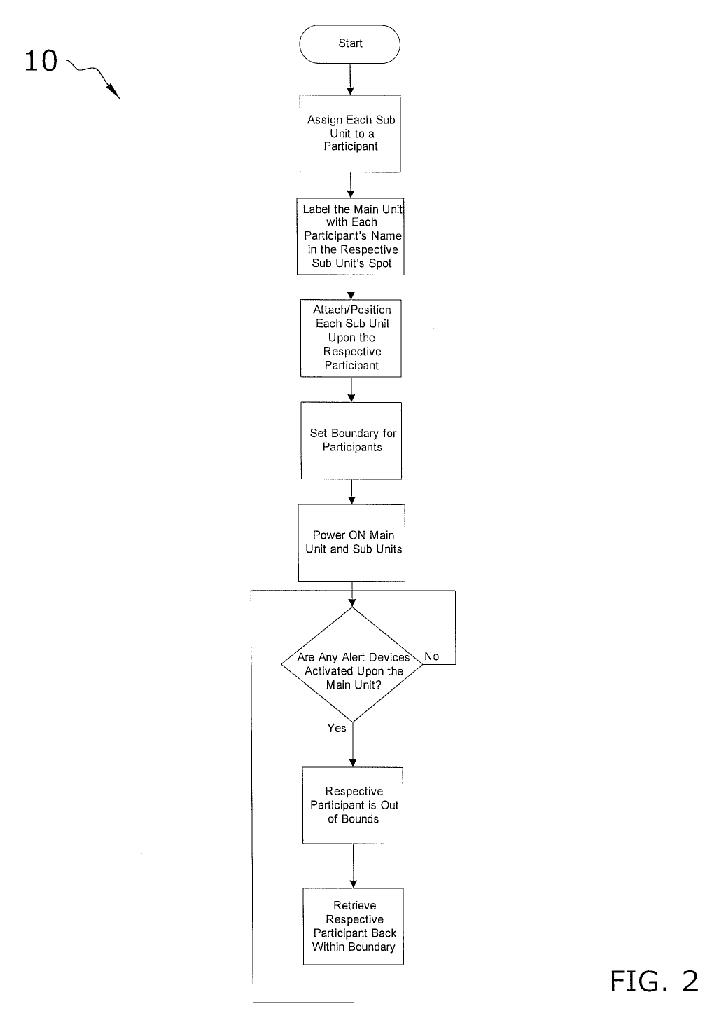

The sub unit 40 receives the first signal when the sub unit 40 is within the predetermined distance of the base unit 20. The sub unit 40 subsequently transmits a second signal to the base unit 20 when the sub unit 40 receives the first signal and the base unit 20 receives the second signal transmitted by the sub unit 40. The sub unit 40 transmits a third signal to the base unit 20 when the sub unit 40 does not receive the first signal before expiration of a timer. The base unit 20 also includes at least one first alarming device 32, 35, wherein the first alarming device 32, 35 is activated upon the base unit 20 when the base unit 20 receives the third signal thus alerting the base unit 20 that at least one sub unit 40 is beyond the predetermined distance (i.e. boundary line 14) as illustrated in FIGS. 1 and 2.

The present invention may be utilized in a plurality of applications. One such application is in the context of a teacher and class, wherein the teacher is required to monitor the class while the class is playing outside. The teacher may assign each student a sub unit 40 to keep in close proximity of the respective student. It is appreciated that the sub unit 40 may be worn upon the student, fixedly attached to the student or simply carried by the student. Each sub unit 40 preferably includes a unique address identifiable by the base unit 20. The teacher may thus monitor the students via the base unit 20.

Another application that could by utilized with the present invention is in patient care, such as elderly individuals in a nursing home and/or individuals that have Alzheimer's disease. The present invention would be utilized in a similar manner to the teacher and student scenario described above. It is appreciated that the present invention may be utilized in a variety of applications and scenarios rather than the scenarios described above. It is also appreciated that the present invention is adapted for use both indoors and outdoors. In the below description the individual operating the base unit 20 is referred to as the leader and the individual(s) holding the sub unit 40 is referred to as the participant; however this in no way is considered to be limiting in the area of who can utilize the present invention.

### B. Base Unit

The base unit 20 serves as the controlling device for the present invention, wherein the base unit 20 is preferably in communication with each of the sub units 40 utilized as illustrated in FIG. 1. The base unit 20 further communicates with each of the sub units 40 in parallel communication. The base unit 20 may be comprised of various configurations. The base unit 20 is preferably comprised of a portable structure that may be easily carried by the leader of a group of participants. It is appreciated that the base unit 20 may also be mounted to a fixed object if the designated area 16 for the participants is generally in a fixed location (i.e. classroom, playground, etc.).

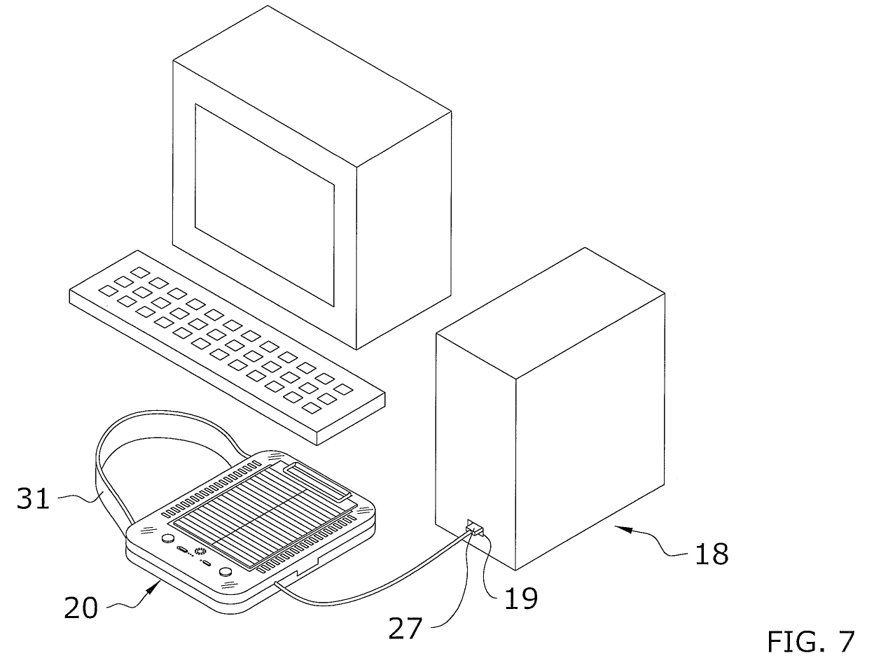

The base unit 20 is comprised of a durable configuration that may withstand extended use and harsh weather conditions. It is also appreciated that the base unit 20 may be waterproof or weatherproof so as to not damage the internal electrical components if the base unit 20 is exposed to wet conditions. The base unit 20 may be comprised of a plurality of configurations, such as but not limited to plastic or metal. In the preferred embodiment the base unit 20 is preferably comprised of an injection molded plastic. The base unit 20 may also include an elongate first strap 31 to allow the base unit 20 to be more easily carried as shown in FIG. 7. The first strap 31 is preferably comprised of a shoulder strap configuration.

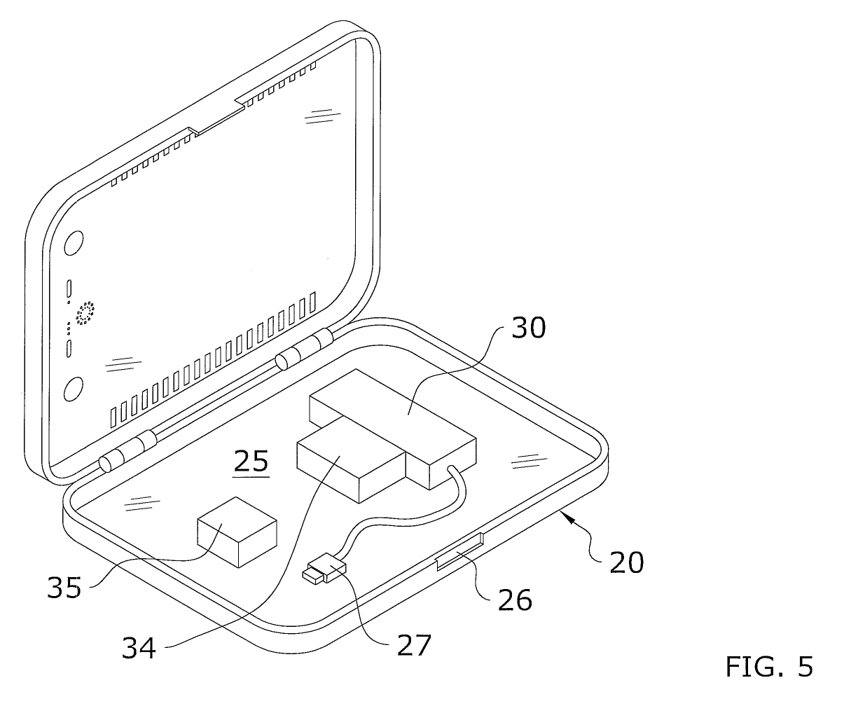

The base unit 20 may be comprised of a plurality of various shaped configurations, such as but not limited to rectangular, circular or triangular. In the preferred embodiment of the present invention the base unit 20 is preferably comprised of a clip board style configuration, wherein the clip board is hingedbly opened and closed revealing a first cavity 25 to house the electrical components of the base unit 20 as illustrated in FIG. 5. It is appreciated that the first cavity 25 may also house other objects such as extra identifier sheets 28 and writing utensils.

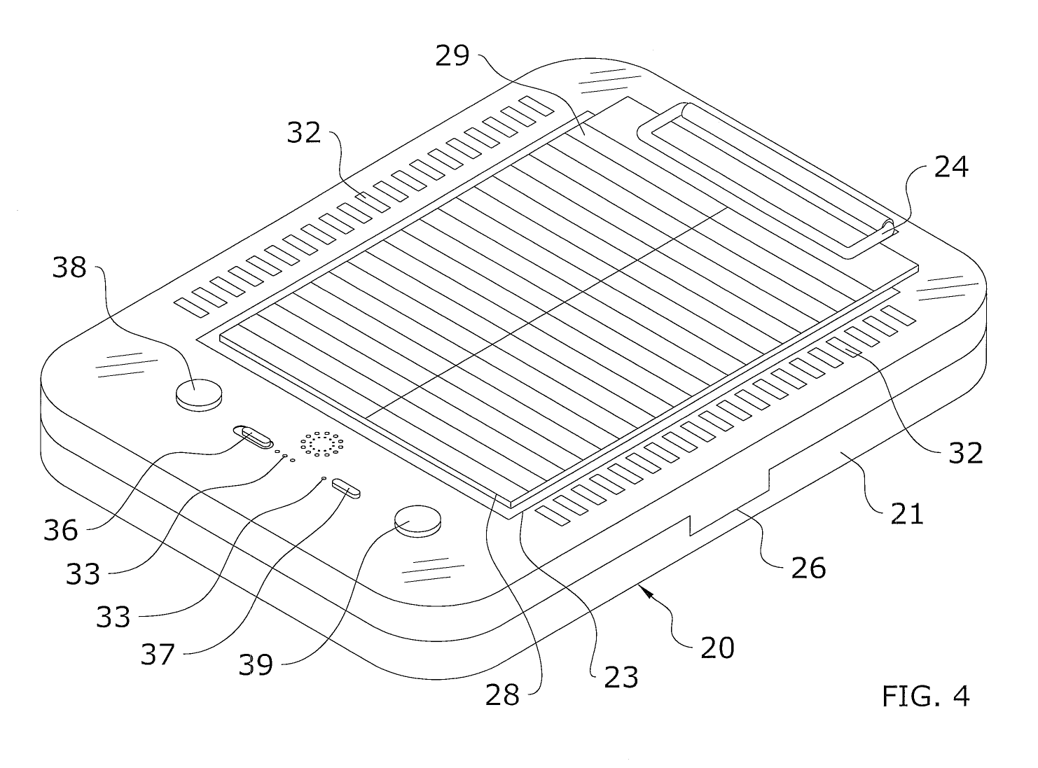

The base unit 20 includes a first outer casing 21 to surround and encompass the first cavity 25. The first outer casing 21 preferably includes a front panel 23 as illustrated in FIG. 4. The front panel 23 is preferably comprised of a similar shape as the identifier sheet 28 utilized by the base unit 20. The front panel 23 allows the identifier sheet 28 to rest flat against the base unit 20.

The base unit 20 also includes an attachment member 24 positioned adjacent an outer border of the front panel 23 as illustrated in FIGS. 4 and 7. The attachment member 24 is preferably comprised of a clip configuration common in the art of clip boards and serves to secure the identifier sheet 28 upon the base unit 20. It is appreciated that the base unit 20 may include various configuration attachment members 24 (i.e. VELCRO, adhesive, etc.) all which attach the identifier sheet 28 to the base unit 20.

The plurality of first alerting lights 32 are positioned along opposing sides of the front panel 23 and extend through a portion of the first outer casing 21 as shown in FIGS. 1, 4 and 7. The plurality of first alerting lights 32 are preferably aligned equidistant along the longitudinal axis of the front panel 23. The base unit 20 may also include a plurality of viewing slots aligned with the plurality of alerting lights 32, wherein the viewing slots serve as viewing windows and may include a protective outer covering (i.e. transparent plastic, glass, etc.) for the first alerting lights 32.

The base unit 20 also preferably includes a securing structure 26 to secure the first outer casing 21 closed when access to the interior components of the first cavity 25 is not desired as illustrated in FIGS. 4 and 5. The securing structure 26 may be comprised of a plurality of configurations all which effectively secure the hinged first outer casing 21 shut when desired.

The base unit 20 may also include a serial adaptor 27 extending outwardly from the base unit 20 and electrically connected to the base transceiver 30 as illustrated in FIGS. 5 and 7. The serial adaptor 27 may also be positioned within the first cavity 25 when the serial adaptor 27 is not in use. The serial adaptor 27 serves to electrically connect the base transceiver 30 to a personal computer 18. The serial adaptor 27 may be comprised of various connector configurations (i.e. RS-232, USB, etc.). It is appreciated that the base unit 20 may also include a wireless device to wirelessly connect the base transceiver 30 to the personal computer 18.

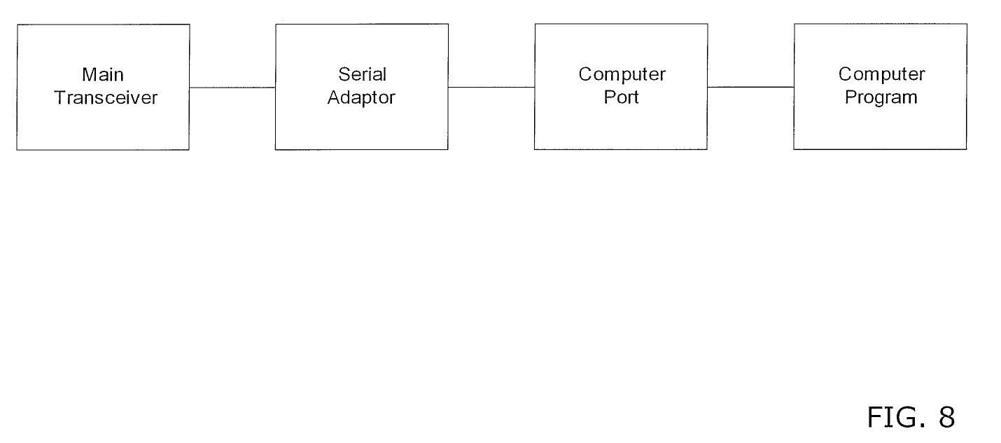

The personal computer 18 utilized with the present invention includes a port 19 to electrically receive the serial adaptor 27 of the base unit 20 as illustrated in FIG. 7 and 8. The personal computer 18 also includes a computer program to access the base transceiver 30. The computer program may be comprised of various formats, such as but not limited to a Microsoft Windows application.

When accessing the base transceiver 30 via the personal computer 18 the operator may activate the desired sub unit 40 to be utilized by entering in or activating a corresponding IP (Internet Protocol) address of the sub unit 40. The base unit 20 may also be setup to detect sub units 40 in close proximity and then the operator simply activates the desired sub units 40 utilizing the computer program. Likewise, the operator may also deactivate a particular sub unit 40 so that the base unit 20 does not communicate with that particular sub unit 40.

When activating a particular IP address of a particular sub unit 40 the operator also preferably assigns the particular sub unit 40 and IP address to a particular first alerting light 32. The first alerting light 32 activated will only visually alert the leader with respect to the corresponding IP address of the respective sub unit 40. A benefit of utilizing particular IP addresses for each sub unit 40 is to allow multiple base units 20 to operate in close proximity without interfering with each other, such as but not limited to a situation involving multiple class rooms in a particular playground. It is appreciated that the unique address given to each sub unit 40 may be comprised of various types of unique addresses not necessarily an IP address. The computer program may also shield sub units 40 from the base unit 20 so the base unit 20 is not able to detect the sub units 40.

It is appreciated that the computer program may include a plurality of various functions to add, delete and identify sub units 40 upon a particular base unit 20. It is also appreciated that the computer program may also add, delete and identify particular base units 20 controlling sub units 40. The computer program may serve various other purposes also, such as but not limited to controlling the type of alerting mechanism 32, 35, 52 and 56 (i.e. visual, audible, vibrating, etc.) that the sub unit 40 or base unit 20 utilizes. It is also appreciated that while utilizing the computer program it may be necessary to turn ON the desired base unit 20 and sub units 40 that are too be utilized.

The identifier sheet 28 is positioned and attached upon the front panel 23 of the base unit 20 as illustrated in FIGS. 1, 4 and 7. The identifier sheet 28 preferably includes a plurality of identifier slots 29 to correspondingly align with each of the first alerting lights 32 adjacent the front panel 23 of the first outer casing 21. The participant's name is preferably labeled within each identifier slot 29 corresponding with the particular sub unit 40 the participant is given, wherein the respective sub unit's 40 corresponding first alerting light 32 is electrically assigned to the particular IP address of the respective sub unit 40. It is appreciated that the present invention may include various types of writing areas rather than the described identifier sheet 28, such as but not limited to dry erase board, chalk board or electronic writing board.

### C. Base Transceiver

The base transceiver 30 is preferably positioned within the first cavity 25 of the base unit 20 as illustrated in FIG. 5. The base transceiver 30 may be comprised of various types of transceivers all which are capable of transmitting a signal and receiving a signal. It is appreciated that the base transceiver 30 may also be comprised of a separate transmitter and receiver electrically coupled together. The base transceiver 30 is electrically connected to the serial adaptor 27 and also electrically connected to each of the first alerting lights 32. The base transceiver 30 is preferably electrically connected to each of the first alerting lights 32 in a parallel configuration so as to continue normal functioning when one of the first alerting lights 32 is activated or not in use.

The first alerting lights 32 are preferably comprised of LEDs, wherein the first alerting lights 32 effectively notify the leader if a particular sub unit 40 is beyond the boundary line 14 of the designated area 16 as illustrated in FIG. 1. A first speaker 35 may also be electrically connected to the base transceiver 30, wherein the first speaker 35 outputs an audible alert if a sub unit 40 goes beyond the designated area 16. Further, a vibrating device may also be electrically connected to the base transceiver 30 to alert the leader if the base unit 20 is brought beyond the boundary line 14 and out of the designated area 16.

The base transceiver 30 is also preferably electrically connected to an antenna. The antenna may be comprised of various configurations all which effectively receive and transmit a signal to and from the base transceiver 30. Some examples of antenna configurations utilized with the present invention include a spiral antenna and a loop antenna.

The base transceiver 30 transmits a first signal outwards to each of the activated sub transceivers 50 of the sub units 40. The first signal may be comprised of various frequencies. The frequency utilized with the preferred embodiment is preferably in the 433 MHz range. The strength of the first signal may also be altered via a distance switch 36 electrically connected to the base transceiver 30 and adjustable by the leader. The strength of the first signal is preferably such that the first signal does not propagate outwards beyond a certain predetermined distance (i.e. 15 meters, 30 meters, 46 meters, 61 meters, 150 meters, etc.).

The strength of the first signal transmitted by the base transceiver 30 may be adjusted by manually adjusting the distance switch 36. It is appreciated that the base unit 20 includes an amplifier electrically connected to the base transceiver 30 and the distance switch 36 to allow adjustment of the first signal strength. The amplifier may also be positioned within the first cavity 25. It is also appreciated that the distance switch 36 may be comprised of various configurations, such as a rocker switch, push-button configuration and a slider switch. A plurality of first indicator lights 33 may also be positioned adjacent the distance switch 36 to notify the leader what the predetermined distance is currently set at as illustrated in FIG. 4.

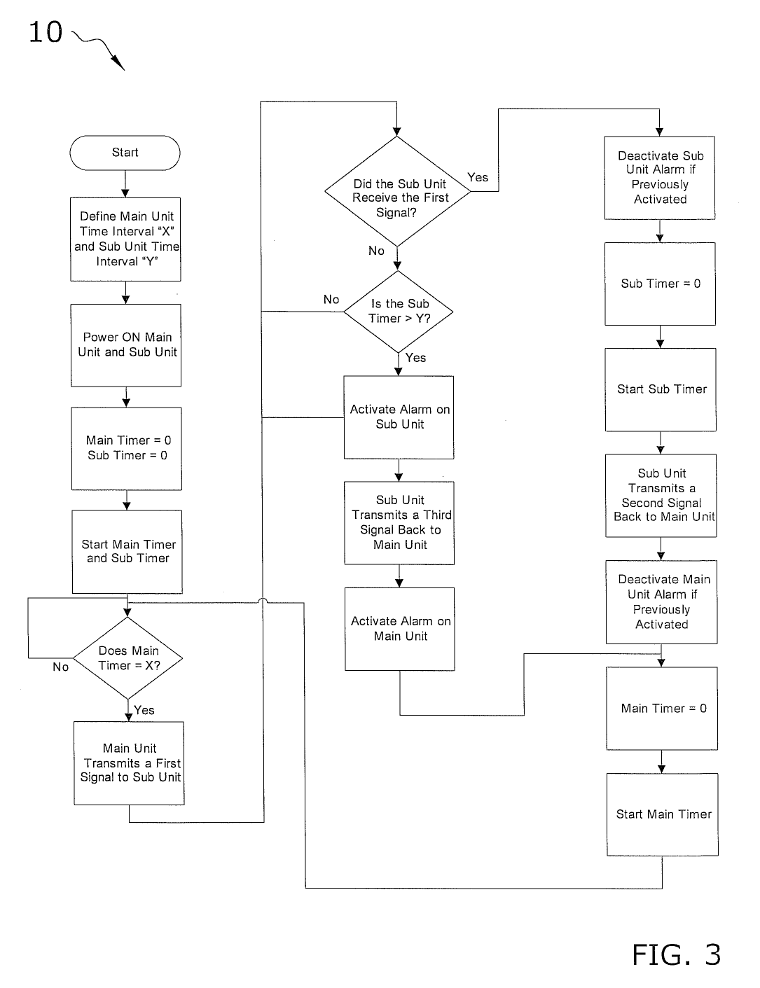

The base transceiver 30 preferably transmits the first signal at a predetermined time interval as illustrated in FIG. 3. The time interval is preferably substantially short to prevent the participants from straying too far beyond the designated area 16 between the transmitting of the first signals from the base transceiver 30. In the preferred embodiment of the present invention the time interval is set at 10 seconds, wherein the base transceiver 30 transmits the first signal toward the sub transceiver 50 of the sub units 40 every 10 seconds. The time interval is preferably controlled by a type of timer or clock electrically connected to the base transceiver 30.

The time interval may also be overridden by a call button 38 electrically connected to the base transceiver 30 and positioned upon the first outer casing 21 of the base unit 20 as illustrated in FIG. 4. The call button 38 serves to activate the second alerting devices 52, 56 of all of the sub units 40 currently activated and thus to tell the participants to return to the leader. It is appreciated that the call button 38 may be comprised of various configurations, such as a rocker switch and a push-button configuration.

The time interval may further be overridden by a search button 39 electrically connected to the base transceiver 30 and positioned upon the first outer casing 21 of the base unit 20 as illustrated in FIG. 4. The search button 39 serves to transmit the first signal from the base transceiver 30 to check to see if all of the sub units 40 currently activated are within the designated area 16. It is appreciated that the search button 39 may be comprised of various configurations, such as a rocker switch and a push-button configuration.

The base transceiver 30 also includes a first power switch 37 electrically connected to a first battery 34 and positioned upon the first outer casing 21 of the base unit 20 as illustrated in FIG. 4. It is appreciated that the first power switch 37 may be comprised of various configurations, such as a rocker switch and a push-button configuration. The first battery 34 is preferably positioned within the first cavity 25 of the base unit 20 and is electrically connected to the base transceiver 30, wherein the first battery 34 provides power to the base transceiver 30.

The first battery 34 may be comprised of various configurations, such as but not limited to chargeable and rechargeable. The first battery 34 may also be comprised of various voltages. In the preferred embodiment of the present invention the first battery 34 is preferably comprised of a working voltage ranging between 2.7 and 3.6 volts.

### D. Sub Unit

The sub unit 40 serves as a locator device for the present invention, wherein the sub unit 40 is preferably in communication with the base unit 20 utilized as illustrated in FIG. 1. The sub unit 40 may be comprised of various configurations. The sub unit 40 is comprised of a portable structure that may be easily carried by the participant. The sub unit 40 is comprised of a durable configuration that may withstand extended use and harsh weather conditions.

It is also appreciated that the sub unit 40 may be waterproof or weatherproof so as to not damage the internal electrical components if the sub unit 40 is exposed to wet conditions. The sub unit 40 may be comprised of a plurality of configurations, such as but not limited to plastic or metal. In the preferred embodiment the sub unit 40 is preferably comprised of an injection molded plastic. It is appreciated that the present invention may includes a plurality of sub units 40 (i.e. 10, 20, 40, etc.), wherein the sub units 40 may be activated and/or deactivated upon needed use via the computer program communicating with the base unit 20.

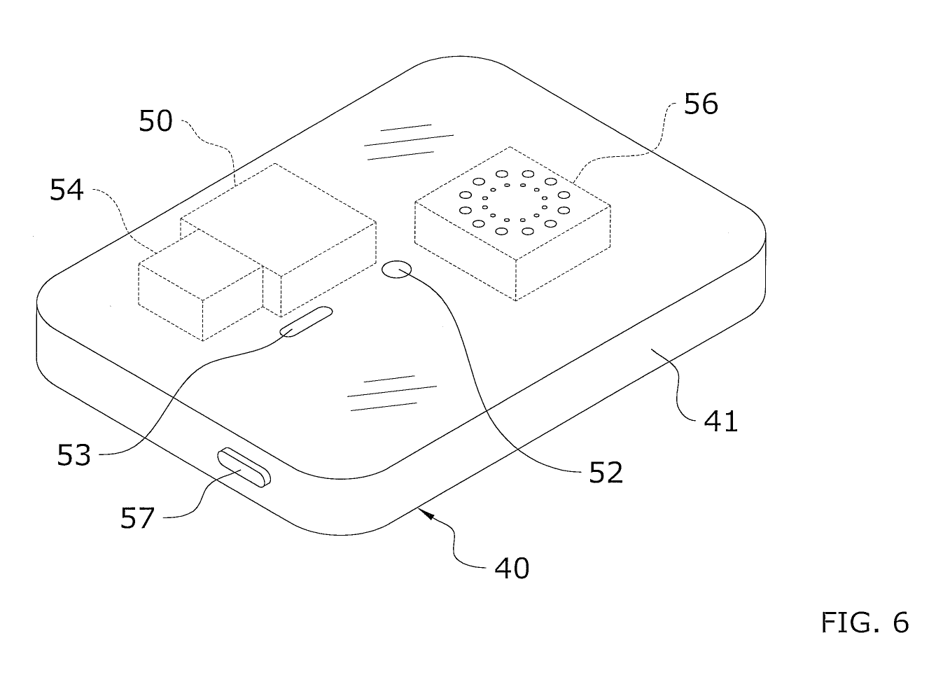

The sub unit 40 may be comprised of a plurality of shaped configurations, such as but not limited to rectangular, circular or triangular. In the preferred embodiment of the present invention the sub unit 40 is preferably comprised of a substantially small size to be carried by a participant without substantially affecting the normal activity of the participant. The sub unit 40 includes a second outer casing 41 to surround and encompass a second cavity as shown in FIG. 6. The second outer casing 41 may be opened by hinging methods or other various methods to access the internal electrical components within the second cavity.

### E. Sub Transceiver

The sub transceiver 50 is preferably positioned within the second cavity of the sub unit 40 as illustrated in FIG. 6. The sub transceiver 50 may be comprised of various types of transceivers all which are capable of transmitting a signal and receiving a signal. It is appreciated that the sub transceiver 50 may also be comprised of a separate transmitter and receiver electrically coupled together. The sub transceiver 50 is electrically connected to the second alerting light 52 to activate the second alerting light 52 when the sub transceiver 50 does not receive the first signal.

Each sub unit 40 includes a particular IP address that is preferably assigned to the internal circuitry of the sub unit 40 during manufacturing. The IP address allows the sub unit 40 to solely communicate with the base unit 20 that has the respective IP address activated. The sub transceiver 50 is also preferably electrically connected to an antenna. The antenna may be comprised of various configurations all which effectively receive and transmit a signal to and from the sub transceiver 50. Some examples of antenna configurations utilized with the present invention include a spiral antenna and a loop antenna.

The second alerting light 52 is preferably comprised of an LED, wherein the second alerting light 52 effectively notifies the leader of the sub unit 40 when the sub unit 40 and participant are beyond the boundary line 14 of the designated area 16 as illustrated in FIG. 1. A second speaker 56 may also be electrically connected to the sub transceiver 50, wherein the second speaker 56 outputs an audible alert if a sub unit 40 goes beyond the boundary line 14 of the designated area 16 as illustrated in FIG. 1 and 3. Further, a vibrating device may also be electrically connected to the sub transceiver 50 to alert the leader if the sub unit 40 is brought beyond the boundary line 14 and out of the designated area 16.

The sub transceiver 50 transmits a second signal outwards the base unit 20 when the sub transceiver 50 receives the first signal. The second signal may be comprised of various frequencies. The frequency utilized with the preferred embodiment is preferably in the 433 MHz range. The strength of the second signal is preferably strong enough to effectively reach the base unit 20 even if the sub unit 40 is beyond the predetermined distance from the base unit 20. It is appreciated that the sub unit 40 may include an amplifier electrically connected to the sub transceiver 50 to allow adjustment of the second signal strength. The amplifier may also be positioned within the second cavity.

The sub transceiver 50 preferably activates the second alerting lights 52, the second speaker 56 and/or vibrating mechanism at an expiration of a timer. The predetermined time for the timer is preferably substantially short to prevent the participants from straying too far beyond the designated area 16 between the transmitting of the second signals from the sub transceiver 50. If the timer expires before receiving the first signal the second alerting devices 52, 56 of the sub unit 40 are activated and the sub transceiver 50 also sends the sends a third signal to the base transceiver 30 to activate the first alerting devices 32, 35, wherein the base transceiver 30 is able to distinguish between the second signal and the third signal of the sub transceiver 50.

In the preferred embodiment of the present invention the timer is set at 15 seconds, wherein the sub transceiver 50 activates the second alerting lights 52, the second speaker 56 and/or vibrating mechanism of the sub unit 40 if the sub unit 40 does not receive the first signal from the base transceiver 30 and base unit 20 in 15 seconds. The timer may also be overridden by the call button 38 or the search button 39 of the base unit 20. The length of the timer of the sub transceiver 50 is also of a greater time length than the time interval of the base transceiver 30 to allow time for the sub transceiver 50 to receive the first signal from the base transceiver 30.

The sub transceiver 50 also includes a second power switch 57 electrically connected to a second battery 54 and positioned upon the second outer casing 41 of the sub unit 40 as illustrated in FIG. 6. It is appreciated that the second power switch 57 may be comprised of various configurations, such as a rocker switch and a push-button configuration. The second power switch 57 may also be electrically connected to a second indicator light 53, wherein the leader and/or participant will be able to see if the sub transceiver 50 is ON via the second indicator light 53.

The second battery 54 is preferably positioned within the second cavity of the sub unit 40 and is electrically connected to the sub transceiver 50, wherein the second battery 54 provides power to the sub transceiver 50. The second battery 54 may be comprised of various configurations, such as but not limited to chargeable and rechargeable. The second battery 54 may also be comprised of various voltages.

### F. Pouch

The pouch 60 serves to hold or encompass the sub unit 40 to prevent the sub unit 40 from being damaged during use and also to allow the participants to easily carry the sub unit 40. The pouch 60 is preferably substantially small in size so as to be easily carried by the participants. The pouch 60 is also preferably lightweight and may be comprised of various materials, such as but not limited to plastic or fabric. The pouch 60 may also be substantially weatherproof and/or waterproof to prevent the sub unit 40 from being damaged if the pouch 60 becomes wet.

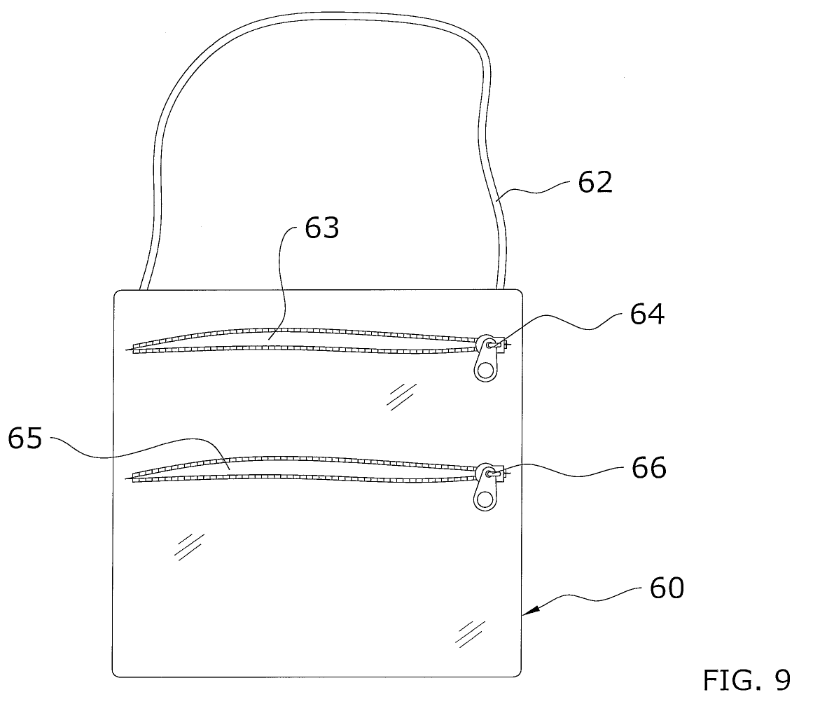

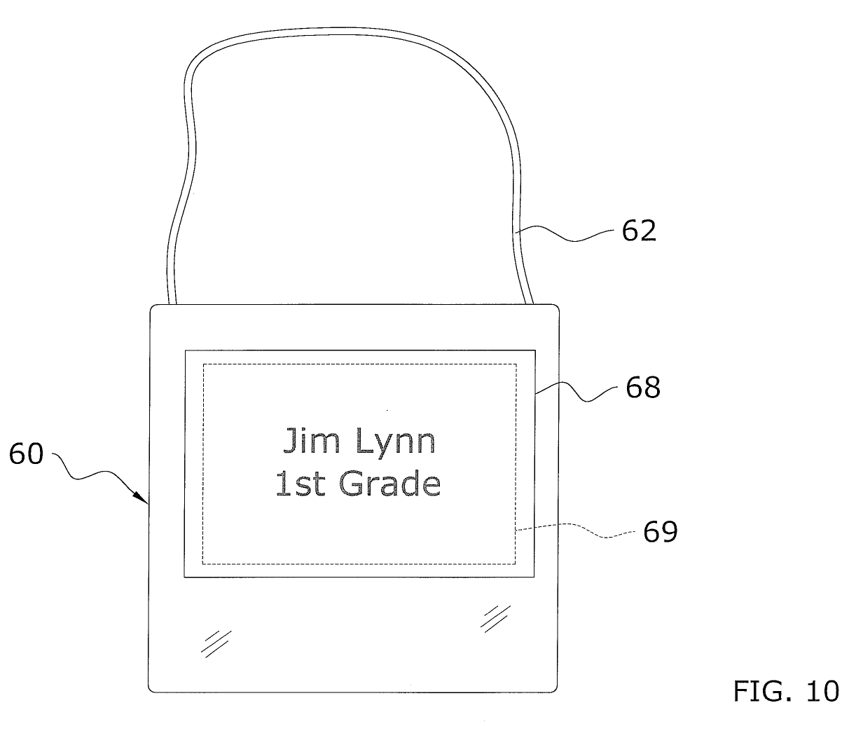

The pouch 60 preferably includes an elongated second strap 62 to allow the participant to wear the pouch 60 around their neck as shown in FIGS. 9 and 10. The pouch 60 is preferably worn in a similar manner as a pendant. It is appreciated that the second strap 62 may also be adjustable and/or comprised of a breakaway structure to accommodate for various size participants. It is also appreciated that the pouch 60 may be worn upon various places of the participant, such as but not limited to around the waste as a fanny pack configuration or around the wrist as a watch configuration.

The pouch 60 preferably includes a first pocket 63 and a second pocket 65 positioned upon a first side of the pouch 60 as illustrated in FIG. 9. The first pocket 63 and the second pocket 65 are both preferably closable, wherein the first pocket 63 includes a first sealing member 64 and the second pocket 65 includes a second sealing member 66. The first sealing member 64 and the second sealing member 66 may be comprised of various configurations, such as but not limited to a zipper mechanism, VELCRO or snaps. The sub unit 40 is preferably positioned within the first pocket 65 of the pouch 60. The second pocket 63 of the pouch 60 may be utilized to carry various personal items of the participant (i.e. money, candy, etc.).

The pouch 60 also preferably includes a sleeve 68 positioned upon the second side of the pouch 60 as illustrated in FIG. 10. The sleeve 68 is preferably comprised of a transparent plastic material. The sleeve 68 preferably houses an identifier tag 69 as illustrated in FIG. 10. The identifier tag 69 preferably includes the participant's name in case a particular pouch 60 and sub unit 40 become lost or the participant stores their pouch 60 among other pouches 60. It is appreciated that the participant's name upon the identifier tag 69 preferably matches up with the name upon the corresponding identifier slot 29 upon the identifier sheet 28.

### G. In Use

In use, the base unit 20 is first connected to the personal computer 18 via connecting the serial adaptor 27 to the port 19 as illustrated in FIGS. 7 and 8, while ensuring that both the personal computer 18 and the base unit 20 are powered ON. The desired IP addresses of the sub units 40 to be utilized are now activated upon the base unit 20 via utilizing the computer program on the personal computer 18. It is appreciated that the sub units 40 may need to be turned ON and in close proximity to the base unit 20 when adding each unique IP address of a respective sub unit 40 to the base unit 20. The base unit 20 may now be disconnected from the personal computer 18. It is appreciated that the operator may have to power OFF the base unit 20 to safely disconnect the base unit 20 from the personal computer 18.

The activated sub units 40 are now assigned to each participant by inserting the respective sub unit 40 within a given pouch 60. Each participant's name is also labeled next to the corresponding first alerting light 32 upon the identifier sheet 28 and within the identifier slot 29 as illustrated in FIG. 2. The corresponding participant's name is also preferably written or typed on an identifier tag 69 and positioned within the sleeve 68 of the pouch 60 containing the respective sub unit 40. The leader also ensures that each sub unit 40 is powered ON when inserting the sub units 40 within the respective pouch 60. The leader also ensures that the base unit 20 is powered ON. The leader also sets the desired predetermined distance that the participant may stray from the base unit 20.

The participant may now be given the pouch 60 with the activated sub unit 40. The leader now is able to monitor the participants via the base unit 20, wherein a given first alerting light 32 will turn ON and/or the first speaker 35 will sound if a respective participant and sub unit 40 go beyond the boundary line 14 of the designated area 16 and into the out-of-bounds area 15. When the leader desires to call back all of the participants the leader simply pushes the call button 38, thus alerting all of the sub units 40 and respective participants that they must return to the leader.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. An individual monitoring system, comprising:
a base unit including at least one first alarming device, wherein said base unit transmits a first signal a predetermined distance, wherein said first signal does not transmit beyond said predetermined distance; and
at least one sub unit to receive said first signal when said at least one sub unit is within said predetermined distance of said base unit;
wherein said at least one sub unit transmits a second signal to said base unit when said at least one sub unit receives said first signal and wherein said base unit receives said second signal transmitted by said at least one sub unit;
wherein said at least one sub unit transmits a third signal to said base unit if said at least one sub unit does not receive said first signal before expiration of a timer;
wherein said third signal activates said at least one first alarming device thus alerting said base unit that said at least one sub unit is beyond said predetermined distance.

2. The individual monitoring system of claim 1, wherein said base unit transmits said first signal to said at least one sub unit at a time interval.

3. The individual monitoring system of claim 1, wherein said at least one first alarming device is comprised of a visual alarm.

4. The individual monitoring system of claim 1, wherein said at least one sub unit includes a unique address.

5. The individual monitoring system of claim 4, wherein said base unit identifies said unique address of said at least one sub unit.

6. The individual monitoring system of claim 5, wherein said at least one first alarming device includes at least one visual alarm, wherein said at least one visual alarm correspondingly activates upon said base unit receiving said third signal from a respective said unique address of said at least one sub unit.

7. The individual monitoring system of claim 1, wherein said at least one sub unit includes at least one second alarming device.

8. The individual monitoring system of claim 7, wherein said at least one second alarming device is activated if said at least one sub unit does not receive said first signal before expiration of said timer.

9. The individual monitoring system of claim 8, wherein said timer is reset when said at least one sub unit receives said first signal of said base unit.

10. The individual monitoring system of claim 7, wherein said at least one second alerting device is comprised of an audible alarm.

11. The individual monitoring system of claim 1, wherein said predetermined distance is altered by adjusting a strength of said first signal transmitted by said base unit.

12. The individual monitoring system of claim 1, wherein said at least one sub unit includes a plurality of sub units, wherein said plurality of sub units each include a unique address.

13. The individual monitoring system of claim 12, wherein said at least one first alarming device includes a plurality of first alarming devices, wherein said plurality of first alarming devices are individually electrically connected to a respective said unique address of said plurality of sub units.

14. The individual monitoring system of claim 1, wherein said base unit includes a serial adaptor to electrically connect to a port of a personal computer.

15. The individual monitoring system of claim 14, wherein said at least one sub unit includes a unique address and wherein said unique address is activated upon said base unit via a computer program upon said personal computer.

16. The individual monitoring system of claim 1, including a pouch, wherein said sub unit is positioned within said pouch.

17. The individual monitoring system of claim 16, wherein said pouch includes a neck strap.

18. The individual monitoring system of claim 1, wherein said base unit is comprised of a clip board configuration.

19. An individual monitoring system, comprising:
a base unit to transmit a first signal a predetermined distance, wherein said first signal does not transmit beyond said predetermined distance; and
at least one sub unit including at least one second alarming device, wherein said at least one sub unit receives said first signal when said at least one sub unit is within said predetermined distance of said base unit;
wherein said at least one sub unit transmits a second signal to said base unit when said at least one sub unit receives said first signal and wherein said base unit receives said second signal transmitted by said at least one sub unit;
wherein said at least one second alarming device is activated if said at least one sub unit does not receive said first signal before expiration of a timer.

20. An individual monitoring system, comprising:
a base unit including at least one first alarming device, wherein said base unit transmits a first signal a predetermined distance, wherein said first signal does not transmit beyond said predetermined distance;
at least one sub unit to receive said first signal when said at least one sub unit is within said predetermined distance of said base unit;
wherein said at least one sub unit transmits a second signal to said base unit when said at least one sub unit receives said first signal and wherein said base unit receives said second signal transmitted by said at least one sub unit;
wherein said at least one sub unit transmits a third signal to said base unit if said at least one sub unit does not receive said first signal before expiration of a timer;
wherein said third signal activates said at least one first alarming device thus alerting said base unit that said at least one sub unit is beyond said predetermined distance;
wherein said base unit transmits said first signal to said at least one sub unit at a time interval;
wherein said at least one sub unit includes a unique address and wherein said base unit identifies said unique address of said at least one sub unit;
wherein said at least one first alarming device includes at least one visual alarm, wherein said at least one visual alarm correspondingly activates upon said base unit receiving said third signal from a respective said unique address of said at least one sub unit;
wherein said at least one sub unit includes at least one second alarming device and wherein said at least one second alarming device is activated if said at least one sub unit does not receive said first signal before expiration of said timer;
wherein said timer is reset when said at least one sub unit receives said first signal of said base unit;
wherein said at least one second alerting device includes an audible alarm;
wherein said predetermined distance is altered by adjusting a strength of said first signal transmitted by said base unit;
wherein said base unit includes a serial adaptor to electrically connect to a port of a personal computer;
wherein said at least one sub unit includes said unique address and wherein said unique address is activated upon said base unit via a computer program upon said personal computer; and
a pouch, wherein said at least one sub unit is positioned within said pouch; wherein said base unit is comprised of a clip board configuration.
